(19) United States
(12) Patent Application Publication
(10) Pub. No.: US 2026/0223890 A1
(43) Pub. Date: Aug. 6, 2026

(54) Low-calorie, protein-enhanced pet treats

(71) Applicant: Daniel Smith, Sandwich, MA (US)

(72) Inventor: Daniel Smith, Sandwich, MA (US)

(21) Appl. No.: 19/044,658

(22) Filed: Feb. 4, 2025

(51) Int. Cl. A23K 40/30; A23K 10/30; A23K 20/147; A23K 20/158; A23K 50/42

(52) U.S. Cl. CPC A23K 40/30; A23K 10/30; A23K 20/147; A23K 20/158; A23K 50/42

(57) ABSTRACT

A method for producing low-calorie, protein-enhanced pet treats using air-popped popcorn as a base, coated with refined coconut oil and animal protein powder. The treats are particularly suitable for dog training due to their low caloric content while maintaining palatability through protein enhancement. The manufacturing process includes air-popping corn kernels, selecting whole popped kernels, applying melted refined coconut oil, and coating with animal protein powder. The resulting treats provide a healthy alternative to conventional high-calorie training treats.

### BACKGROUND OF THE INVENTION

Pet obesity has become a significant concern in modern veterinary medicine, with studies indicating that over 50% of dogs in the United States are overweight or obese. This epidemic is particularly problematic in the context of pet training, where treats are frequently used as positive reinforcement. Traditional training treats, while effective for behavioural modification, often contribute substantially to daily caloric intake, potentially leading to weight management issues and associated health problems.

Current market solutions for training treats typically fall into several categories, each with notable limitations. Conventional manufactured treats often contain artificial preservatives, colors, and flavors, which may cause adverse reactions in some animals. These treats frequently rely on animal by-products of questionable nutritional value and incorporate fillers such as wheat, corn, or soy, which can trigger allergic responses in sensitive animals. Additionally, these treats typically range from 3 to 5 calories per piece, making them problematic for extended training sessions where numerous treats may be dispensed.

Alternative low-calorie options currently available include freeze-dried meats and vegetables. While these options address some nutritional concerns, they present their own challenges. Freeze-dried meat treats, though natural and protein-rich, remain relatively expensive to produce and purchase, limiting their practical use in high-volume training scenarios. Vegetable-based treats, while low in calories, often lack the palatability necessary to maintain an animal's interest during training sessions.

Previous attempts to create low-calorie training treats have explored various approaches. Some manufacturers have reduced treat size to lower caloric content, but this approach often results in treats that are too small for practical handling during training sessions. Others have experimented with fiber-rich ingredients to create bulk while minimizing calories, but these attempts frequently result in treats with poor palatability or digestibility issues.

The use of popcorn in pet food applications has been limited, despite its potential advantages as a low-calorie, digestible base ingredient. Prior art includes popcorn as a filler in dry dog food formulations and as a component in baked pet treats. However, these applications typically involve the addition of significant quantities of oil during the popping process, which increases caloric content and can lead to rancidity concerns during storage. Furthermore, previous popcorn-based pet products have not effectively addressed the need for high palatability and protein content essential for training treats. Existing patents in this field have focused primarily on various methods of creating meat-based or synthetic treats, often involving complex manufacturing processes and numerous ingredients.

The market lacks a solution that effectively combines the following desirable characteristics in a single training treat: low caloric content, high palatability, good digestibility, simple ingredient list, cost-effective manufacturing process, and adequate size for practical handling during training sessions. This gap in the market has created a need for innovation in pet treat manufacturing, particularly for products specifically designed for training purposes.

Additionally, environmental and sustainability concerns have become increasingly important in pet food manufacturing. Current treat production methods often require significant energy input for processes such as baking, freeze-drying, or dehydrating. These processes can contribute to higher manufacturing costs and environmental impact, creating a need for more efficient and sustainable production methods.

The present invention addresses these limitations by providing a novel approach to manufacturing pet treats that combines the inherent advantages of air-popped popcorn with the palatability of animal protein powder, using minimal processing and natural ingredients. This invention represents a significant advancement in the field of pet treats, particularly for training applications where the combination of low caloric content and high palatability is essential.

### SUMMARY OF INVENTION

The present invention provides an innovative solution in the field of pet nutrition and training, specifically addressing the need for low-calorie, high-palatability treats through a novel manufacturing process and product composition. This invention comprises a unique combination of air-popped popcorn as a base substrate, refined coconut oil as an adherent medium, and animal protein powder as a palatability enhancer, resulting in a pet treat particularly suited for training applications.

### Product Composition and Characteristics

The invention's primary substrate consists of specially selected air-popped popcorn kernels, characterized by their complete expansion and structural integrity. These kernels undergo a rigorous selection process to ensure uniform size and texture, with only fully popped, whole kernels being retained for further processing. The popcorn base provides a unique combination of low caloric density and optimal size for handling during training sessions.

The second component comprises a precise application of refined coconut oil, specifically selected for its molecular stability and controlled melting point characteristics. The coconut oil serves as both an adherent medium and a preservative agent, while contributing minimal calories to the final product. The oil application process maintains strict temperature control between 76° F. and 78° F. (24.4° C. to 25.6° C.) to achieve optimal coating without compromising the structural integrity of the popcorn base.

The third key component consists of finely processed animal protein powder, derived from premium sources including, but not limited to, chicken, beef, lamb, or salmon. The protein powder undergoes specialized processing to achieve particle sizes between 50 and 150 microns, ensuring optimal adherence to the oil-coated popcorn surface while maintaining uniform distribution.

### Manufacturing Process Innovation

The manufacturing process represents a significant advancement in pet treat production technology. The process begins with the air-popping of corn kernels under controlled humidity conditions (relative humidity maintained between 45% and 55%) to ensure optimal expansion. This step eliminates the need for traditional oil-popping methods, substantially reducing the caloric content of the final product.

Following the popping process, the kernels undergo a proprietary selection procedure utilizing specifically designed screening equipment that separates fully popped kernels from partially popped or un-popped kernels. This selection process ensures consistent product quality and optimal texture in the final treat.

The selected kernels then enter a controlled coating chamber where refined coconut oil is applied through a precision spraying system. The oil application process maintains specific temperature parameters to ensure proper coating while preventing oil absorption into the popcorn structure. This precise control results in a uniform surface coating that serves as an ideal substrate for the subsequent protein application.

The protein powder application occurs immediately following the oil coating, utilizing a tumbling process that ensures even distribution of the protein powder across the treated kernels. The tumbling chamber's rotation speed and duration are carefully controlled to maximize protein adherence while minimizing structural damage to the popcorn base.

### Product Advantages and Applications

The resulting product offers several distinct advantages over existing pet treats. The air-popped base provides a low-calorie foundation, typically containing 60-70% fewer calories than conventional training treats of similar size. The protein coating delivers enhanced palatability while contributing to the treat's nutritional value, with protein content ranging from 15% to 25% by weight in the finished product.

The treats maintain structural integrity during handling and storage, with a shelf life exceeding 12 months when properly packaged. The coconut oil coating provides resistance to moisture absorption while minimizing oxidation of the protein component, resulting in stable palatability throughout the product's shelf life.

### Versatility and Customization

The invention allows for significant customization through variations in the protein coating type and concentration. Different protein sources can be utilized to accommodate various pet preferences and dietary requirements. The manufacturing process can be adjusted to produce treats of varying sizes while maintaining consistent quality and characteristics.

### Quality Control and Safety Features

The manufacturing process incorporates multiple quality control points, including moisture content monitoring, structural integrity verification, and protein coating consistency checks. The finished product undergoes testing for moisture content (target range 3-4%), protein adherence strength (minimum 85% retention during standard handling), and palatability verification through standardized acceptance testing protocols.

### Environmental Considerations

The manufacturing process demonstrates environmental advantages through reduced energy consumption compared to traditional baking or dehydration methods. The air-popping process requires approximately 40% less energy than conventional treat manufacturing processes, while producing minimal waste through the recycling of unselected kernels.

This detailed summary of invention represents a comprehensive overview of both the product and process innovations incorporated in this pet treat manufacturing technology. The combination of novel processing techniques with carefully selected ingredients results in a product that effectively addresses the current market need for low-calorie, high-palatability pet training treats.

### BRIEF DESCRIPTION OF THE DRAWINGS

FIG. 1 illustrates a process flow diagram showing the sequential steps for manufacturing protein-enhanced pet treats.

FIG. 2 depicts a cross-sectional view showing the layered structure and composition of the protein-enhanced pet treat.

FIG. 3 presents a quality control parameters table detailing critical specifications and acceptable tolerances for the manufacturing process.

FIG. 4 illustrates a system configuration diagram showing the three distinct processing units: the air popping chamber, sifting drum, and flavoring drum, along with their interconnections.

FIG. 5 provides detailed specifications for the base formulation and nutritional analysis of the finished product.

### DETAILED DESCRIPTION OF THE FIGURES

The present invention is described in detail with reference to the accompanying drawings, which illustrate preferred embodiments without limiting the scope of the invention. The drawings demonstrate both the manufacturing process and the resulting product characteristics that enable the production of consistent, high-quality, protein-enhanced pet treats.

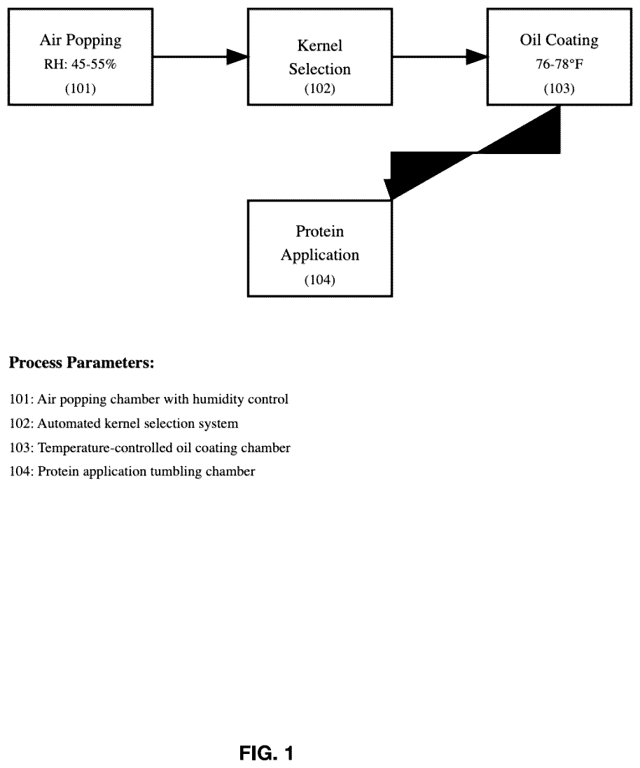

FIG. 1 illustrates the comprehensive manufacturing process flow for producing protein-enhanced pet treats. The process begins with an air popping operation, designated as component (101), which operates under precisely controlled humidity conditions maintained between 45-55% relative humidity. This specific humidity range has been determined to be optimal for achieving maximum kernel expansion while maintaining proper moisture content in the final product. Following the popping process, the expanded kernels proceed through an automated kernel selection system (102), which employs specialized screening mechanisms to separate fully expanded kernels from partially popped or unpopped kernels. This selection process is crucial for ensuring consistent product quality and uniform coating in subsequent steps. The selected kernels then enter a temperature-controlled oil coating chamber (103), where the refined coconut oil is applied at a carefully maintained temperature between 76-78° F. This precise temperature control ensures optimal oil viscosity for uniform coating while preventing excessive oil absorption into the popped kernel structure. The final stage comprises the protein application system (104), where a tumbling chamber facilitates uniform distribution of the protein powder coating onto the oil-coated kernels, creating the finished product with precise nutritional specifications.

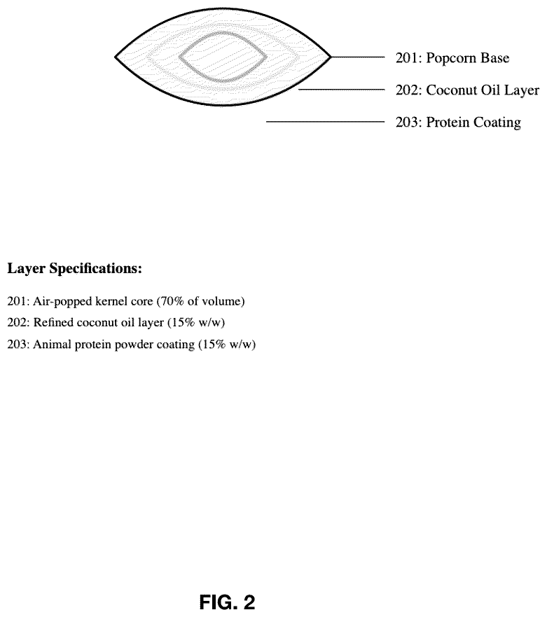

FIG. 2 provides a detailed cross-sectional representation of the finished pet treat's layered structure, illustrating the precise composition and arrangement of components that contribute to its unique characteristics. The illustration reveals three distinct layers, each serving a specific function in the final product. The innermost layer consists of the air-popped kernel core (201), which serves as the popcorn base and comprises approximately 70% of the total product volume. This core provides the low-calorie, crunchy foundation of the treat while maintaining structural integrity during bandling and storage. The intermediate layer consists of a precisely applied refined coconut oil coating (202), which constitutes 15% weight/weight of the total composition. This layer serves dual purposes; it acts as an adherent medium for the protein coating while contributing to the treat's palatability and shelf stability. The outermost layer consists of an animal protein powder coating (203), also representing 15% weight/weight of the final product. This protein layer provides the essential nutritional enhancement while maintaining the treat's appeal to pets. The proportions of these layers have been optimized through extensive testing to achieve the desired balance of nutritional value, palatability, and structural stability.

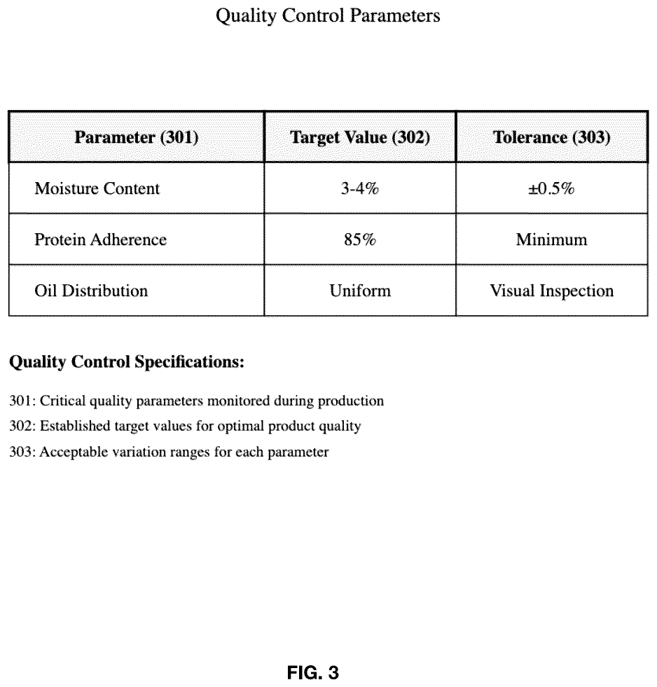

FIG. 3 presents a comprehensive quality control parameters table that delineates the critical specifications and tolerances essential for maintaining consistent product quality. The table is organized into three primary columns: Parameter (301), Target Value (302), and Tolerance (303). The moisture content specification requires maintenance between 3-4% with a tolerance of ±0.5%, which is crucial for ensuring product stability, shelf life, and proper texture. The protein adherence parameter specifies a minimum threshold of 85%, ensuring adequate protein delivery in the final product while maintaining coating integrity during handling and storage. The oil distribution parameter requires uniform coverage, verified through standardized visual inspection protocols. This visual inspection process includes specific criteria for evaluating coating consistency and identifying any areas of inadequate coverage. These parameters collectively ensure that each batch meets the established quality standards and delivers consistent nutritional value.

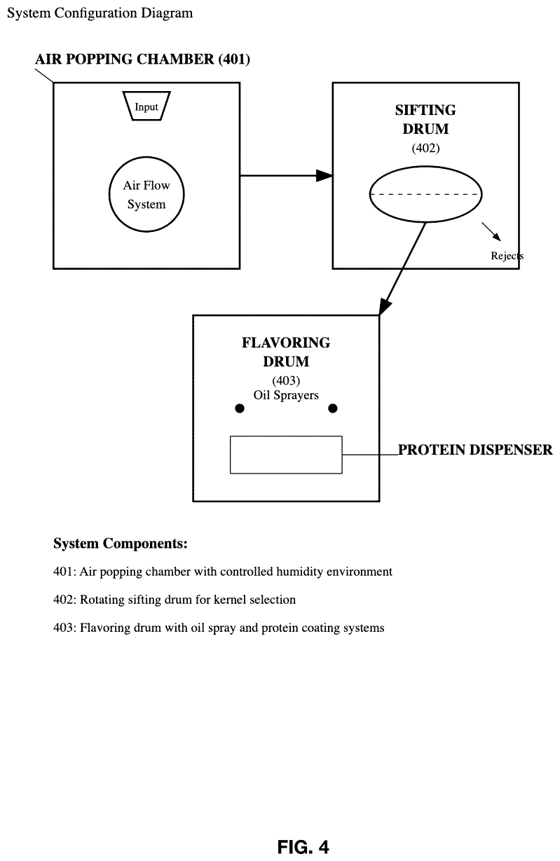

FIG. 4 depicts a detailed system configuration showing three distinct processing units that work in sequence to produce the protein-enhanced pet treats. The air popping chamber (401) is equipped with an advanced air flow system that maintains precise humidity control while efficiently popping the corn kernels. This unit is specifically designed to achieve optimal expansion rates while minimizing kernel breakage. The expanded kernels then transfer directly to the sifting drum (402), which employs a rotating mechanism with specialized screening surfaces to effectively separate fully expanded kernels from partial or unpopped kernels. This drum operates at a carefully calibrated rotation speed to ensure thorough separation while preventing damage to the expanded kernels, The selected kernels then proceed to the flavoring drum (403), which features both an oil spraying system and a protein powder dispenser. The oil sprayers are strategically positioned to provide uniform coverage, while the protein dispenser ensures even distribution of the protein powder coating. The separation of these processes into distinct chambers enables precise control over each stage of production while maintaining optimal processing conditions specific to each step. Each chamber is equipped with appropriate monitoring systems to ensure process parameters remain within specified ranges.

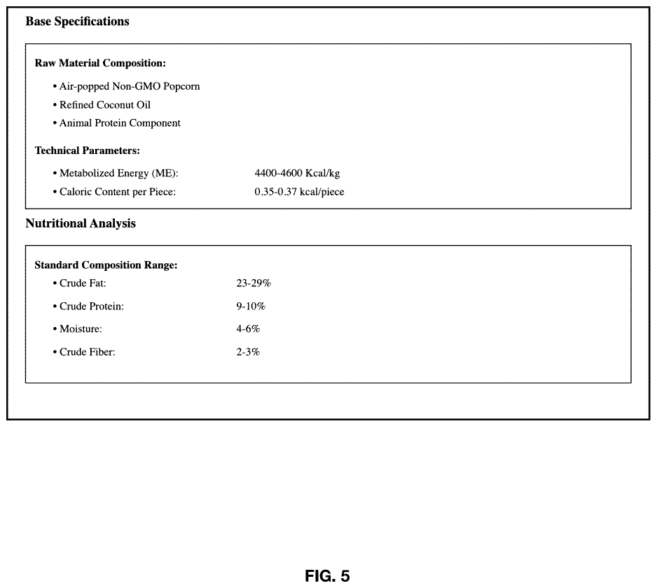

FIG. 5 provides comprehensive product specifications, including detailed raw material composition, technical parameters, and nutritional analysis. The base specifications section details the precise requirements for each raw material component, including the non-GMO popcorn kernels, refined coconut oil, and animal protein powder. The technical parameters specify the critical metabolized energy range of 4400-4600 Kcal/kg and a precisely controlled caloric content of 0.35-0.37 kcal per piece, which is essential for portion control in training applications. The nutritional analysis section presents standard composition ranges that must be maintained in the finished product, including crude fat content of 23-29%, crude protein levels of 9-10%, moisture content of 4-6%, and crude fiber content of 2-3%. These specifications are monitored through regular testing protocols to ensure consistent nutritional value in the finished product.

The drawings collectively illustrate the innovative aspects of both the manufacturing process and the resulting product, demonstrating the technical solutions developed to address the challenges of producing consistent, high-quality, protein-enhanced pet treats. Each figure provides essential information about specific aspects of the invention, enabling those skilled in the art to understand and implement the described manufacturing process and quality control measures effectively.

What is claimed is:

1. A method of manufacturing a protein-enhanced pet treat, said method comprising sequentially processing raw non-GMO popcorn kernels through separate processing units by: introducing said kernels into an air popping chamber maintained at a controlled humidity to create expanded popcorn kernels; transferring said expanded popcorn kernels to a rotating sifting drum for selecting fully expanded kernels; and conveying selected kernels to a flavoring drum where refined coconut oil and animal protein powder are sequentially applied to create protein-enhanced pet treats having a caloric content between 0.35 and 0.37 kcal per piece.

2. The method of claim 1, wherein said air popping chamber maintains relative humidity between 45% and 55% during the air-popping process, and wherein said air popping chamber comprises an air flow system configured to optimize kernel expansion.

3. The method of claim 1, wherein said rotating sifting drum employs a mechanism to separate fully expanded kernels from partially popped and unpopped kernels, achieving a selection accuracy of at least 99% for fully expanded kernels.

4. The method of claim 1, wherein said flavoring drum comprises an oil spraying system configured to apply said refined coconut oil at a temperature between 76° F. and 78° F., and a separate protein powder dispenser configured to apply said animal protein powder uniformly to oil-coated kernels.

5. The method of claim 1, wherein said expanded popcorn kernels comprise approximately 70% of total product volume, said refined coconut oil comprises approximately 15% by weight of the finished product, and said animal protein powder comprises approximately 15% by weight of the finished product.

6. A protein-enhanced pet treat manufactured according to the method of claim 1, comprising an air-popped non-GMO popcorn kernel base, a refined coconut oil coating on said popcorn kernel base, and an animal protein powder coating adhered to said coconut oil coating, wherein said pet treat has a metabolized energy between 4400 and 4600 Kcal/kg.

7. The protein-enhanced pet treat of claim 6, wherein said treat comprises crude fat content between 23% and 29%, crude protein content between 9% and 10%, moisture content between 4% and 6%, and crude fiber content between 2% and 3%.

8. A system for manufacturing protein-enhanced pet treats, said system comprising three distinct processing units arranged in sequential order: an air popping chamber comprising an air flow system configured to maintain relative humidity between 45% and 55%; a rotating sifting drum comprising a screening mechanism configured to separate fully expanded kernels; and a flavoring drum comprising an oil spraying system and a protein powder dispenser.

9. The system of claim 8, wherein said air popping chamber is configured to achieve kernel expansion of at least 35 times the original kernel volume while maintaining optimal moisture content.

10. The system of claim 8, wherein said rotating sifting drum comprises a mechanism configured to achieve at least 99% selection accuracy for fully expanded kernels, and includes a rejection pathway for partially popped and unpopped kernels.

11. The system of claim 8, wherein said flavoring drum comprises strategically positioned oil sprayers configured to maintain oil temperature between 76° F. and 78° F., and a separate protein powder dispenser configured to achieve uniform coating distribution.

12. A method of quality control for manufacturing protein-enhanced pet treats, said method comprising monitoring moisture content to maintain 3-4% with ±0.5% tolerance throughout processing, verifying protein coating adherence of minimum 85% in said flavoring drum, and confirming uniform oil distribution through standardized visual inspection protocols.

13. The method of claim 12, further comprising verifying finished product specifications comprising: metabolized energy between 4400-4600 Kcal/kg, caloric content between 0.35-0.37 kcal per piece, and a size distribution wherein at least 90% of treats have a diameter between 12 and 15 millimeters.

14. The protein-enhanced pet treat of claim 6, wherein said treat exhibits a shelf life of at least 12 months when stored in a sealed container at room temperature while maintaining protein coating adherence and nutritional specifications within stated ranges.

15. The system of claim 8, further comprising automated transfer mechanisms between said processing units configured to maintain product integrity during transfer between chambers.

16. The method of claim 1, wherein said animal protein powder is selected from the group consisting of lamb meal, dried beef, dried chicken, and salmon meal.

17. The protein-enhanced pet treat of claim 6, wherein said treat contains no added salts or sugars and is configured for use as a training aid with a caloric content at least 50% lower than conventional pet treats of comparable size.

18. The system of claim 8, further comprising environmental control systems for maintaining consistent processing conditions within each chamber and monitoring systems for verifying process parameters in real-time.

19. The method of claim 1, further comprising packaging said protein-enhanced pet treats in a moisture-resistant container with feeding instructions limiting treat dispensation to three treats per pound of animal body weight per day.

20. The method of claim 1, wherein said rotating sifting drum operates at a calibrated rotation speed optimized to ensure thorough separation while preventing damage to expanded kernels during the selection process.
